(19) United States
(12) Patent Application Publication
(10) Pub. No.: US 2008/0122193 A1
(43) Pub. Date: May 29, 2008

(54) Roller board therapeutic apparatus and associated method

(76) Inventor: Clara Ferguson, Dade City, FL (US)

Correspondence Address: ASHKAN NAJAFI, P.A., 6817 SOUTHPOINT PARKWAY, SUITE 2301, JACKSONVILLE, FL, 32216, US

(21) Appl. No.: 11/983,606

(22) Filed: Nov. 13, 2007

Related U.S. Application Data
(60) Provisional application No. 60/861,280, filed on Nov. 29, 2006.

(51) Int. Cl. A63C 17/00; A61H 3/00

(52) U.S. Cl. 280/87.041; 601/23

(57) ABSTRACT

A therapeutic roller board apparatus includes a rigid support board with planar top and bottom sides extending along an entire longitudinal length of the roller board apparatus. The apparatus further includes a plurality of brackets directly coupled to the bottom side of the support board, and a plurality of casters pivotally mated directly to the brackets. A mechanism for maintaining a foot of a user is securely affixed to the top side of the support board such that a longitudinal length of the user foot extends parallel to the longitudinal length of the roller board apparatus. Such a foot maintaining mechanism is adjustably positional along the top side of the support board, and the foot maintaining mechanism is detachably from the support board.

### CROSS REFERENCE TO RELATED APPLICATIONS

This application claims the benefit of U.S. Provisional Application No. 60/861,280, filed Nov. 29, 2006, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to therapeutic apparatuses and, more particularly, to a roller board therapeutic apparatus for assisting a patient to perform rehabilitative exercises and gain strength during transport.

2. Prior Art

Most people who suffer a stroke or a heart attack want to know one thing: “What do I have to do to get back to being myself?”. The answer varies of course, but attitude is a large part of the healing process. The early discharge policies followed by most hospitals nowadays mean that people are likely to arrive home quicker and sicker. Recovery presents more challenges to stroke survivors, who have to adjust to a condition that limits life functions. Although a patient may feel like letting a caregiver take charge, the more a patient can participate the better. An important part of the rehabilitation process is moving about on one's own and exercising, if possible. Many individuals have severely limited mobility as a result of illness or injury and are unable to easily move about. Based on the above mentioned needs, it would be advantageous to provide a means for assisting a user to move about while recuperating from surgery and the like.

U.S. Pat. No. 6,065,763 to Adams discloses a roller bouncer and wave board skate comprising a base plate. A plurality of wheel assemblies is disposed on bottom of the base plate. A top plate is provided. A structure is for biasing the top plate over the base plate. A foot plate supports a shoe of a skater. An assemblage is for attaching the foot plate to the top plate in a removable manner, so that the skater will bounce while skating. Unfortunately, this prior art example does not address the specific needs of a recuperating patient.

U.S. Pat. No. 6,158,753 to Sturbaum discloses a skateboard having independently pivotally mounted trucks affixed to the skateboard axle on the underside of the footboard. Each of the trucks has a pair of wheels that are rounded or tapered in the direction toward the surface on which the skateboard is used to approach a point contact with the surface. Due to the independent suspension of each truck, in the event one of the wheels of one truck encounters an obstacle, that wheel can raise upwardly to ride over the obstruction while all of the other wheels can remain in contact with the surface. As such there is a stable ride even when riding over obstacles and the contour or profile of the wheels tends to also promote a stable ride since the wheel profile tends to push small obstacles away rather than riding over the obstacle. Unfortunately, this prior art example does not address the specific needs of a recuperating patient.

Accordingly, the present invention is disclosed in order to overcome the above noted shortcomings. The present invention is convenient and easy to use, lightweight yet durable in design, and designed for assisting a patient to perform rehabilitative exercises and gain strength during transport. The therapeutic roller board apparatus is simple to use, inexpensive, and designed for many years of repeated use.

### BRIEF SUMMARY OF THE INVENTION

In view of the foregoing background, it is therefore an object of the present invention to provide an apparatus for assisting a patient to perform rehabilitative exercises and gain strength during transport. These and other objects, features, and advantages of the invention are provided by a therapeutic roller board apparatus.

A therapeutic roller board apparatus includes a rigid support board with planar top and bottom sides extending along an entire longitudinal length of the roller board apparatus. Such a top side is provided with a plurality of orifices equidistantly spaced along a plurality of rows extending parallel to the longitudinal length of the roller board apparatus. Each of such rows is effectively located adjacent to opposed ends of the support board such that the rows are situated away from a central region of the support member that is defined intermediately of the straps. The top side further includes a plurality of linear slots formed at opposed longitudinal sides of the support board and registered parallel to the longitudinal length thereof, and the straps are interfitted through the slots and wrapped about the bottom side of the support board.

The apparatus further includes a plurality of brackets directly coupled to the bottom side of the support board, and a plurality of casters pivotally mated directly to the brackets and conveniently spaced from the bottom side of the support board respectively such that the casters freely rotate along a 360 degree arcuate path.

The apparatus further includes a mechanism for advantageously maintaining a foot of a user securely affixed to the top side of the support board such that a longitudinal length of the user foot extends parallel to the longitudinal length of the roller board apparatus. Such a foot maintaining mechanism is adjustably positional along the top side of the support board, and the foot maintaining mechanism is detachably from the support board.

The foot maintaining mechanism includes a plurality of rectilinear and rigid shields effectively traversing the longitudinal length of the roller board apparatus and removably disposing at opposed ends of the top side respectively. Each of such shields extends upwardly from the top side and terminates at a predetermined height thereabove such that heel and metatarsal portions of the user foot are intermediately retained between the shields and thereby prohibited from longitudinally sliding off the top side. The shields are coextensively shaped and have respective longitudinal lengths equal to a width of the top side of the support board.

The foot maintaining mechanism further includes a plurality of flexible straps traversing across the longitudinal length of the roller board apparatus and adjustably positioned about a top surface of the user foot such that the user foot is conveniently prohibited from undesirably lifting off the top side. Each of such straps has opposed end portions detachably engaged to each other.

A method for assisting a patient to perform rehabilitative exercises and gain strength during transport includes the steps of: providing a rigid support board with planar top and bottom sides extending along an entire longitudinal length of the roller board apparatus; directly coupling a plurality of brackets to the bottom side of the support board; pivotally mating a plurality of casters directly to the brackets by spacing the casters from the bottom side of the support board respectively such that the casters freely rotate along a 360 degree arcuate path; maintaining a foot of a user securely affixed to the top side of the support board by positioning a longitudinal length of the user foot parallel to the longitudinal length of the roller board apparatus; and performing an exercise by simulating a walking routine such that the casters glide over a support surface and strengthen user body muscles.

The method further includes the steps of: traversing a plurality of rectilinear and rigid shields along the longitudinal length of the roller board apparatus by removably disposing the shields at opposed ends of the top side respectively; upwardly extending each of the shields from the top side such that the shields terminate at a predetermined height above the top side; and intermediately retaining heel and metatarsal portions of the user foot between the shields and thereby prohibiting the heel and metatarsal portions from longitudinally sliding off the top side.

The method further includes the steps of: traversing a plurality of flexible straps across the longitudinal length of the roller board apparatus; interfitting the straps through the slots; wrapping the straps about the bottom side of the support board; adjustably positioning the straps about a top surface of the user foot such that the user foot is prohibited from undesirably lifting off the top side; and detachably engaging opposed end portions of each of the straps to each other.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a top planar view of a therapeutic roller board apparatus, in accordance with the present invention;

FIG. 2 is a side elevational view of a therapeutic roller board apparatus, in accordance with the present invention;

FIG. 3 is a front elevational view of a therapeutic roller board apparatus, in accordance with the present invention;

FIG. 4 is a bottom planar view of a therapeutic roller board apparatus, in accordance with the present invention;

FIG. 5 is a side elevational view of a therapeutic roller board apparatus, in accordance with the present invention; and

FIG. 6 is a side elevational view of a therapeutic roller board apparatus in use, in accordance with the present invention

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

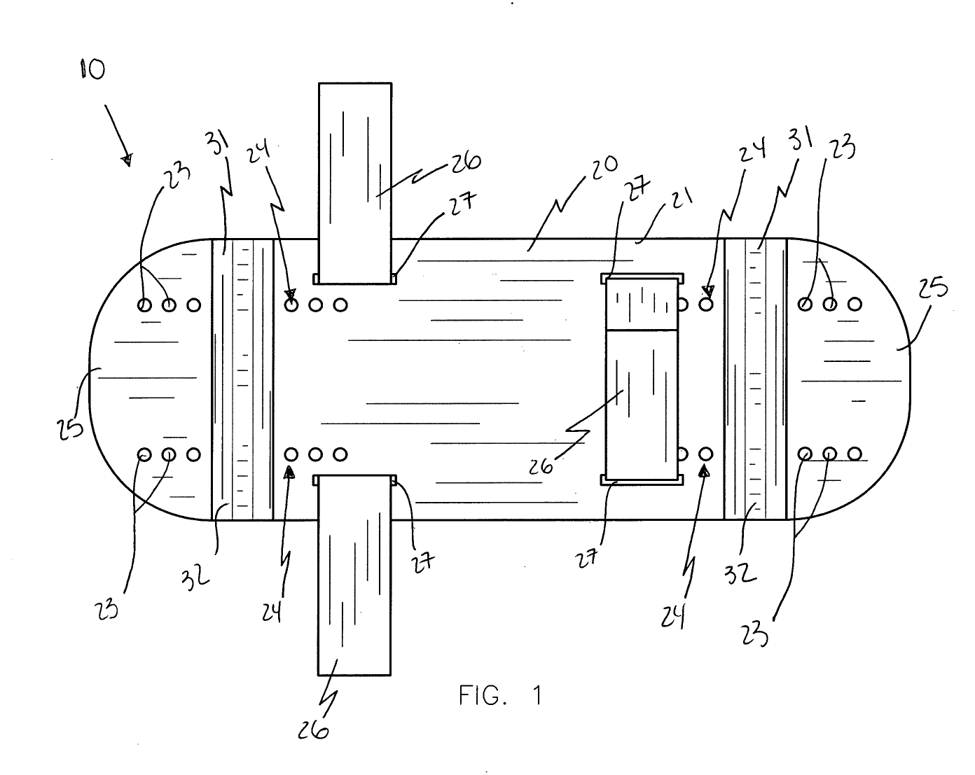

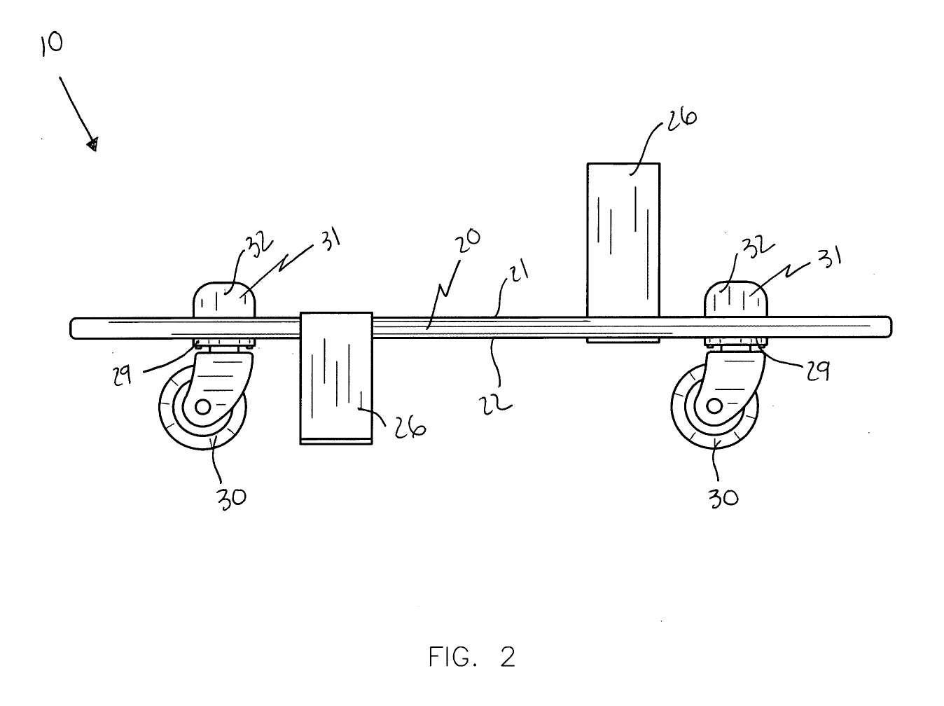

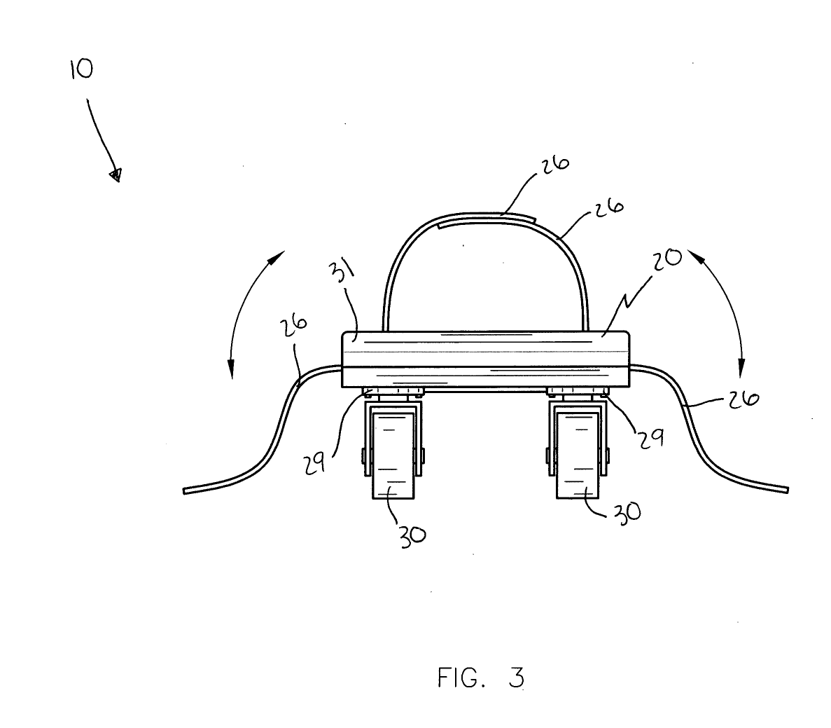

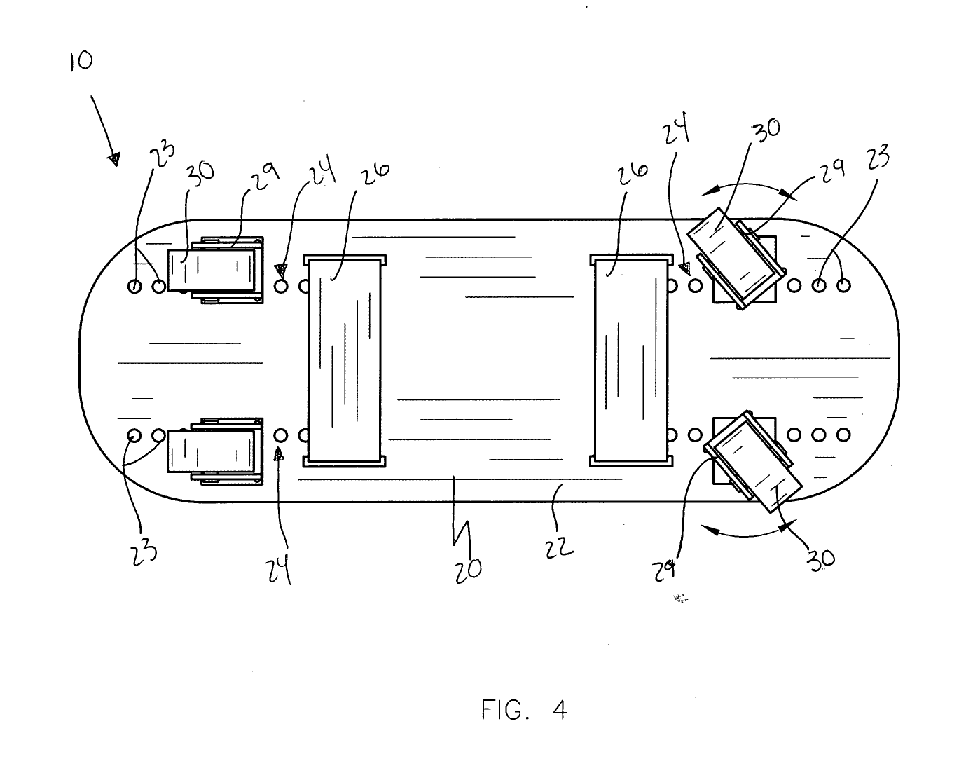

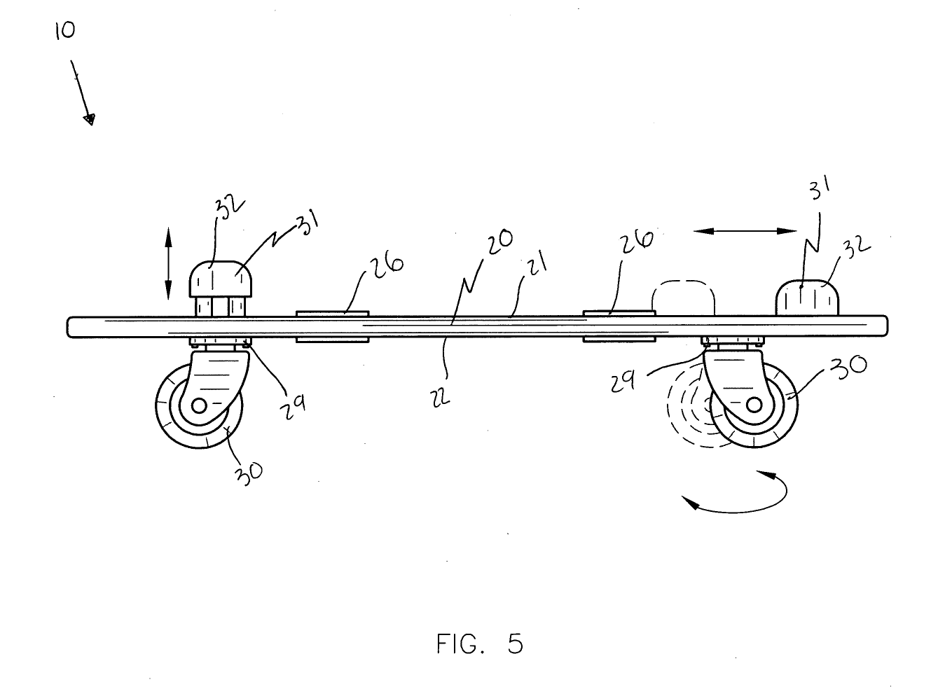

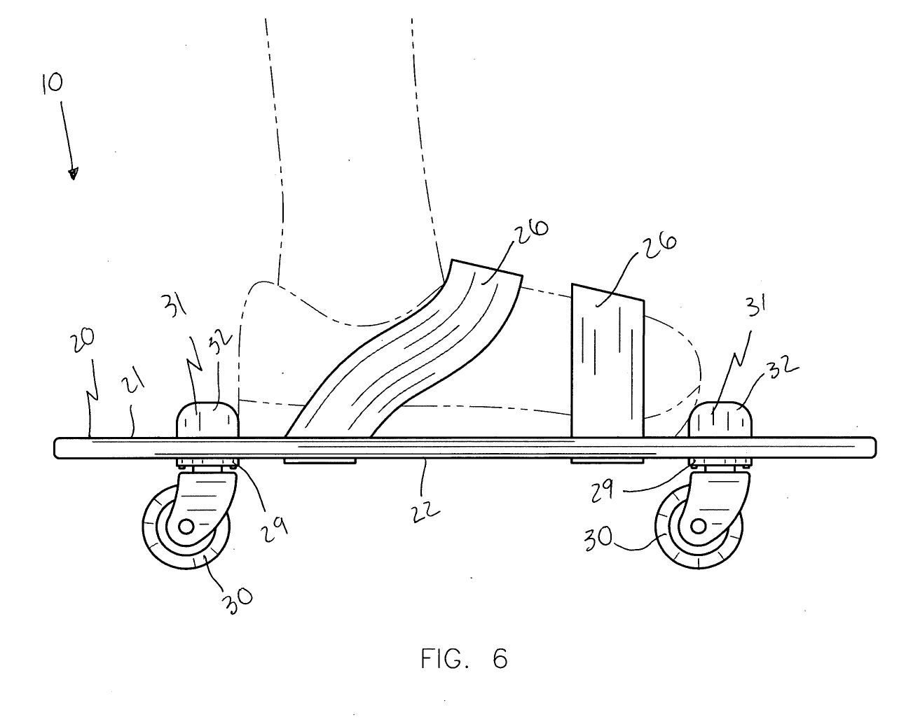

The apparatus of this invention is referred to generally in FIGS. 1-6 by the reference numeral 10 and is intended to protect a therapeutic roller board apparatus. It should be understood that the apparatus 10 may be used to protect many different types of boards and should not be limited in use with only those types of boards mentioned herein.

Referring initially to FIGS. 1, 2, 3, 4, 5 and 6, a therapeutic roller board apparatus 10 includes a rigid support board 20 with planar top and bottom sides 21, 22 extending along an entire longitudinal length of the roller board apparatus 10. Such a top side 21 is provided with a plurality of orifices 23 equidistantly spaced along a plurality of rows 24 extending parallel to the longitudinal length of the roller board apparatus 10. Each of such rows 24 is located adjacent to opposed ends 25 of the support board 20 which is essential such that the rows 24 are situated away from a central region of the support member 20 that is defined intermediately of the straps 26. The top side 21 further includes a plurality of linear slots 27 formed at opposed longitudinal sides of the support board 20 and registered parallel to the longitudinal length thereof, and the straps 26 are interfitted through the slots 27 and wrapped about the bottom side 22 of the support board 20. The support board 20 is provided for suspending a user foot above a ground surface.

Referring again to FIGS. 1, 2, 3, 4, 5 and 6, the apparatus 10 further includes a plurality of brackets 29 directly coupled, without the use of intervening elements, to the bottom side 22 of the support board 20, and a plurality of casters 30 pivotally mated directly, without the use of intervening elements, to the brackets 29 and spaced from the bottom side 22 of the support board 20 respectively which is vital such that the casters 30 freely rotate along a 360 degree arcuate path. The brackets 29 are provided for pivotally mating the casters 30 to the bottom side 22 of the support board 20.

Referring again to FIGS. 1, 2, 3, 4, 5 and 6, the apparatus 10 further includes a mechanism 31 for maintaining a foot of a user securely affixed to the top side 21 of the support board 20 which is important such that a longitudinal length of the user foot extends parallel to the longitudinal length of the roller board apparatus 10. Such a foot maintaining mechanism 31 is adjustably positional along the top side 21 of the support board 20, and the foot maintaining mechanism 31 is detachably from the support board 20.

The foot maintaining mechanism 31 includes a plurality of rectilinear and rigid shields 32 traversing the longitudinal length of the roller board apparatus 10 and removably disposed at opposed ends of the top side 21 respectively. Each of such shields 32 extends upwardly from the top side 21 and terminates at a predetermined height thereabove which is crucial such that heel and metatarsal portions of the user foot are intermediately retained between the shields 32 and thereby prohibited from longitudinally sliding off the top side 21. The shields 32 are coextensively shaped and have respective longitudinal lengths equal to a width of the top side 21 of the support board 20. The rigid shields 32 ensure that the user foot does not slide forward or backward during use of the apparatus 10.

The foot maintaining mechanism 31 further includes a plurality of flexible straps 26 traversing across the longitudinal length of the roller board apparatus 10 and adjustably positioned about a top surface 21 of the user foot which is important such that the user foot is prohibited from undesirably lifting off the top side 21. Each of such straps 26 has opposed end portions detachably engaged to each other. The straps 26 ensure that the user foot remains removably connected to the apparatus 10 during use.

The apparatus includes a rectangular-shaped platform with rounded ends. Such a platform measures eighteen to twenty inches in length and six or seven inches in width, as examples. Of course, such a platform can be produced in a variety of shapes and sizes, as is obvious to a person of ordinary skill in the art. The platform is formed from lightweight plastic material and includes plastic inserts, which are essential for accommodating different shoe sizes. Of course, such a platform and inserts can be formed from a variety of suitable materials, as is obvious to a person of ordinary skill in the art. Two releasable strips are attached to the forward and rear parts of the platform, near the sides, which are critical for securing a user foot to the platform during operating conditions. Of course, such strips can be formed from a variety of suitably releasable materials, as is obvious to a person of ordinary skill in the art.

The apparatus further includes a small, raised panel advantageously extending upward from the forward area of the platform, which is crucial such that the toe of a user foot is abutted there against during operating conditions to reduce the risk of a user foot slipping from the platform and resulting in injury to the user. The underside of the platform includes two casters positioned at a forward area and two casters positioned at a rear thereof. Such casters are fully rotatable, 360 degrees, about a central axis, which is vital for providing movement of the apparatus in any direction.

The present invention, as claimed, provides the unexpected and unpredictable benefit of an apparatus that is convenient and easy to use, is lightweight yet durable in design, and assists a user to move about while recuperating from surgery and the like. Such an apparatus provides individuals with mobility, as well as helping a user regain strength and coordination. The apparatus is beneficial to a wide range of users including those with chronic diseases or mobility problems unrelated to illness or injury. The apparatus is easily manipulated and designed for many years of repeated use. The present invention is inexpensive and can be utilized in private homes as well as health care facilities.

In use, a method for assisting a patient to perform rehabilitative exercises and gain strength during transport includes the steps of: providing a rigid support board 20 with planar top and bottom sides 21, 22 extending along an entire longitudinal length of the roller board apparatus 10; directly coupling, without the use of intervening elements, a plurality of brackets 29 to the bottom side 22 of the support board 20; pivotally mating a plurality of casters 30 directly, without the use of intervening elements, to the brackets 29 by spacing the casters 30 from the bottom side 22 of the support board 20 respectively such that the casters 30 freely rotate along a 360 degree arcuate path; maintaining a foot of a user securely affixed to the top side 21 of the support board 20 by positioning a longitudinal length of the user foot parallel to the longitudinal length of the roller board apparatus 10; and performing an exercise by simulating a walking routine such that the casters 30 glide over a support surface and strengthen user body muscles.

In use, the method further includes the steps of: traversing a plurality of rectilinear and rigid shields 32 along the longitudinal length of the roller board apparatus 10 by removably disposing the shields 32 at opposed ends 25 of the top side 21 respectively; upwardly extending each of the shields 32 from the top side 21 such that the shields 32 terminate at a predetermined height above the top side 21; and intermediately retaining heel and metatarsal portions of the user foot between the shields 32 and thereby prohibiting the heel and metatarsal portions from longitudinally sliding off the top side 21.

In use, the method further includes the steps of: traversing a plurality of flexible straps 26 across the longitudinal length of the roller board apparatus 10; interfitting the straps 26 through the slots 27; wrapping the straps 26 about the bottom side 22 of the support board 20; adjustably positioning the straps 26 about a top surface 21 of the user foot such that the user foot is prohibited from undesirably lifting off the top side 21; and detachably engaging opposed end portions of each of the straps 26 to each other.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A therapeutic roller board apparatus for assisting a patient to perform rehabilitative exercises and gain strength during transport, said roller board apparatus comprising:
a support board having planar top and bottom sides extending along an entire longitudinal length of said roller board apparatus;
a plurality of brackets directly coupled to said bottom side of said support board;
a plurality of casters pivotally mated directly to said brackets and being spaced from said bottom side of said support board respectively such that said casters freely rotate along a 360 degree arcuate path; and
means for maintaining a foot of a user securely affixed to said top side of said support board such that a longitudinal length of the user foot extends parallel to the longitudinal length of said roller board apparatus, said foot maintaining means being adjustably positional along said top side of said support board.

2. The roller board apparatus of claim 1, wherein said foot maintaining means comprises:
a plurality of rectilinear and rigid shields traversing the longitudinal length of said roller board apparatus and being removably disposed at opposed ends of said top side respectively, each of said shields extending upwardly from said top side and terminating at a predetermined height thereabove such that heel and metatarsal portions of the user foot are intermediately retained between said shields and thereby prohibited from longitudinally sliding off said top side.

3. The roller board apparatus of claim 2, wherein said foot maintaining means further comprises:
a plurality of flexible straps traversing across the longitudinal length of said roller board apparatus and being adjustably positioned about a top surface of the user foot such that the user foot is prohibited from undesirably lifting off said top side, each of said straps having opposed end portions detachably engaged to each other.

4. The roller board apparatus of claim 3, wherein said top side is provided with a plurality of orifices equidistantly spaced along a plurality of rows extending parallel to the longitudinal length of said roller board apparatus, each of said rows being located adjacent to opposed ends of said support board and such that said rows are situated away from a central region of said support member that is defined intermediately of said straps.

5. The roller board apparatus of claim 4, wherein said top side further includes a plurality of linear slots formed at opposed longitudinal sides of said support board and registered parallel to the longitudinal length thereof, said straps being interfitted through said slots and wrapped about said bottom side of said support board.

6. The roller board apparatus of claim 1, wherein said shields are coextensively shaped and have respective longitudinal lengths equal to a width of said top side of said support board.

7. A therapeutic roller board apparatus for assisting a patient to perform rehabilitative exercises and gain strength during transport, said roller board apparatus comprising:
a rigid support board having planar top and bottom sides extending along an entire longitudinal length of said roller board apparatus;
a plurality of brackets directly coupled to said bottom side of said support board;
a plurality of casters pivotally mated directly to said brackets and being spaced from said bottom side of said support board respectively such that said casters freely rotate along a 360 degree arcuate path; and
means for maintaining a foot of a user securely affixed to said top side of said support board such that a longitudinal length of the user foot extends parallel to the longitudinal length of said roller board apparatus, said foot maintaining means being adjustably positional along said top side of said support board, said foot maintaining means being detachably from said support board.

8. The roller board apparatus of claim 7, wherein said foot maintaining means comprises:
a plurality of rectilinear and rigid shields traversing the longitudinal length of said roller board apparatus and being removably disposed at opposed ends of said top side respectively, each of said shields extending upwardly from said top side and terminating at a predetermined height thereabove such that heel and metatarsal portions of the user foot are intermediately retained between said shields and thereby prohibited from longitudinally sliding off said top side.

9. The roller board apparatus of claim 8, wherein said foot maintaining means further comprises:
a plurality of flexible straps traversing across the longitudinal length of said roller board apparatus and being adjustably positioned about a top surface of the user foot such that the user foot is prohibited from undesirably lifting off said top side, each of said straps having opposed end portions detachably engaged to each other.

10. The roller board apparatus of claim 9, wherein said top side is provided with a plurality of orifices equidistantly spaced along a plurality of rows extending parallel to the longitudinal length of said roller board apparatus, each of said rows being located adjacent to opposed ends of said support board and such that said rows are situated away from a central region of said support member that is defined intermediately of said straps.

11. The roller board apparatus of claim 10, wherein said top side further includes a plurality of linear slots formed at opposed longitudinal sides of said support board and registered parallel to the longitudinal length thereof, said straps being interfitted through said slots and wrapped about said bottom side of said support board.

12. The roller board apparatus of claim 7, wherein said shields are coextensively shaped and have respective longitudinal lengths equal to a width of said top side of said support board.

13. A method for assisting a patient to perform rehabilitative exercises and gain strength during transport, said method comprising the steps of:
a. providing a rigid support board having planar top and bottom sides extending along an entire longitudinal length of said roller board apparatus;
b. directly coupling a plurality of brackets to said bottom side of said support board;
c. pivotally mating a plurality of casters directly to said brackets by spacing said casters from said bottom side of said support board respectively such that said casters freely rotate along a 360 degree arcuate path;
d. maintaining a foot of a user securely affixed to said top side of said support board by positioning a longitudinal length of the user foot parallel to the longitudinal length of said roller board apparatus; and
e. performing an exercise by simulating a walking routine such that said casters glide over a support surface and strengthen user body muscles.

14. The method of claim 13, wherein step d. comprises the steps of:
traversing a plurality of rectilinear and rigid shields along the longitudinal length of said roller board apparatus by removably disposing said shields at opposed ends of said top side respectively;
upwardly extending each of said shields from said top side such that said shields terminate at a predetermined height above said top side; and
intermediately retaining heel and metatarsal portions of the user foot between said shields and thereby prohibiting the heel and metatarsal portions from longitudinally sliding off said top side.

15. The method of claim 14, wherein step d. further comprises the steps of:
traversing a plurality of flexible straps across the longitudinal length of said roller board apparatus;
interfitting said straps through said slots;
wrapping said straps about said bottom side of said support board;
adjustably positioning said straps about a top surface of the user foot such that the user foot is prohibited from undesirably lifting off said top side; and
detachably engaging opposed end portions of each of said straps to each other.
